(19) United States
(12) Patent Application Publication
(10) Pub. No.: US 2023/0111167 A1
(43) Pub. Date: Apr. 13, 2023

(54) FEATURE SENSOR EFFICIENCY OPTIMIZATION FOR RECOMMENDATION SYSTEM USING DATA ENVELOPMENT ANALYSIS

(71) Applicant: SAP SE, Walldorf (DE)

(72) Inventors: Madhav Bhargava, Kanpur Uttar Pradesh (IN); Kavitha Krishnan, Bangalore (IN); Rahul Pradhan, Mandya (IN); Sivaram Subbiah, Bangalore (IN); Anil Kumar R, Bangalore (IN); Dinesh Kumar, Bangalore (IN); Arivinda RV, Bangalore (IN)

(21) Appl. No.: 17/500,540

(22) Filed: Oct. 13, 2021

(51) Int. Cl. G06Q 30/06; G06N 5/04

(52) U.S. Cl. CPC G06Q 30/0631; G06N 5/04

(57) ABSTRACT

A system and method are disclosed to provide recommendations based on sensor data. The system may include a dynamic customer profile data store that contains electronic records. Each record may be associated with a customer and include a customer identifier and a value for each of a set of customer traits derived from sensor data. A data envelopment analysis platform may access information about a first customer from the dynamic customer profile data store and utilize data envelopment analysis to calculate efficacy scores for the set of customer traits. A recommendation engine may then generate a customer recommendation for the first customer based on the values of each of the set of customer traits and the efficacy scores. Information about a customer action associated with the customer recommendation may be fed back to the data envelopment analysis platform.

### BACKGROUND

Consumers today have many options to select from (e.g., to purchase a product or service, to view online content, to join a community or group, etc.) without sufficient personalized support to make the right choice. For example, retail is a crowded segment where stores have similar product assortments. Every participant in this field would like to get as large a share of the consumer pie as possible. This creates an increased focus where retailers innovate and differentiate themselves with competitive pricing, customer service, and unique experiences to attract and retain a loyal customer base. Moreover, customers today have evolved towards purpose driven retail and look for brands that align with their values. At the same time, consumers have reduced the amount of time they spend with online applications that do not cater their needs or solve their problems.

Hence, retailers and other providers look for mechanisms to serve their customers by name, personal preferences, and serving the “Segment of One”—that is, omni-channel, hyper-personalized offerings, products, and content based on real-time context. Many enterprises currently lack the capability to capture, refine, and learn psychological, geospatial, behavioral, physical, temporal, and other consumer traits via alternate sources as well as the ability use them to improve the relevance of highly personalized recommendations.

It would therefore be desirable to automatically determine appropriate customer recommendations based on sensor data in an efficient and accurate manner.

### SUMMARY

According to some embodiments, methods and systems may facilitate an automatic determination of customer recommendations based on sensor data. The system may include a dynamic customer profile data store that contains electronic records. Each record may be associated with a customer and include a customer identifier and a value for each of a set of customer traits derived from sensor data. A data envelopment analysis platform may access information about a first customer from the dynamic customer profile data store and utilize data envelopment analysis to calculate efficacy scores for the set of customer traits. A recommendation engine may then generate a customer recommendation for the first customer based on the values of each of the set of customer traits and the efficacy scores. Information about a customer action associated with the customer recommendation may be fed back to the data envelopment analysis platform.

Some embodiments comprise: means for accessing, by a data envelopment analysis platform, information about a first customer from a dynamic customer profile data store, wherein the dynamic customer profile data store contains electronic records, each record being associated with a customer and including a customer identifier and a value for each of a set of customer traits derived from sensor data; means for utilizing, by the data envelopment analysis platform, data envelopment analysis to calculate efficacy scores for the set of customer traits; and means for generating, by a recommendation engine, a customer recommendation for the first customer based on the values of each of the set of customer traits and the efficacy scores, wherein information about a customer action associated with the customer recommendation is fed back to the data envelopment analysis platform.

Some technical advantages of some embodiments disclosed herein are improved systems and methods associated with determining appropriate customer recommendations based on sensor data in an efficient and accurate manner.

### BRIEF DESCRIPTION OF THE DRAWINGS

FIG. 1 is a high-level block diagram of a system in accordance with some embodiments.

FIG. 2 illustrates a method according to some embodiments.

FIG. 3 is a table associated with data envelopment analysis in accordance with some embodiments.

FIG. 4 is a data envelopment analysis graph according to some embodiments.

FIG. 5 illustrates ways in which a decision making unit may improve efficiency in accordance with some embodiments.

FIG. 6 is a graph illustrating variable returns to scale according to some embodiments.

FIG. 7 is a graph illustrating DEA with multiple outputs in accordance with some embodiments.

FIG. 8 is a system architecture according to some embodiments.

FIG. 9 is a beauty sensor information collection system in accordance with some embodiments.

FIG. 10 is a dynamic beauty profile according to some embodiments.

FIG. 11 is a more detailed system architecture in accordance with some embodiments.

FIG. 12 is a human machine interface display in accordance with some embodiments.

FIG. 13 is an apparatus or platform according to some embodiments.

FIG. 14 illustrates a dynamic customer profile database in accordance with some embodiments.

FIG. 15 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

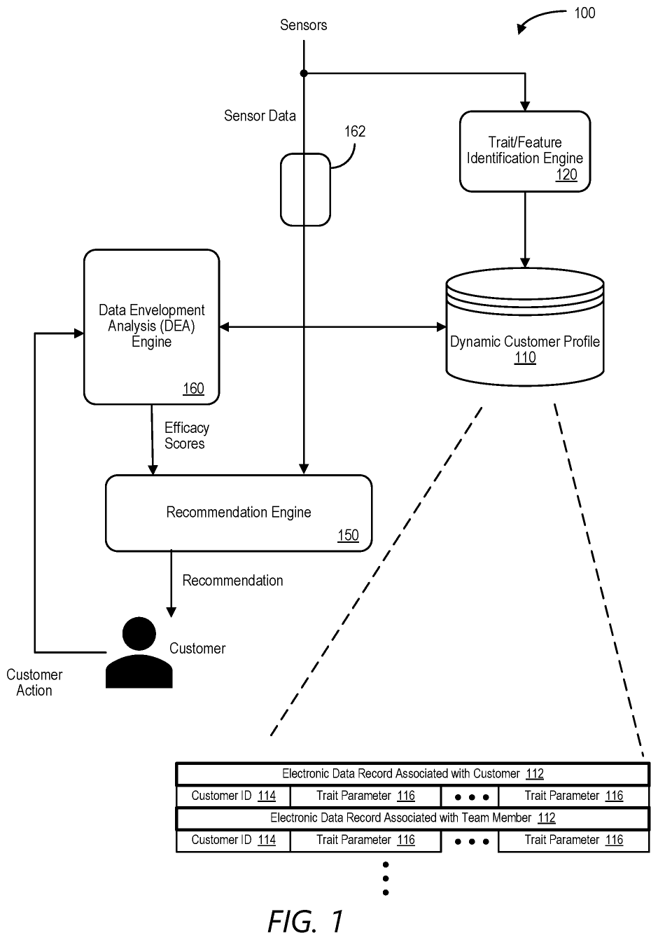

FIG. 1 is a high-level block diagram of a system 100 according to some embodiments of the present invention. In particular, the system 100 includes a recommendation platform 150 that may access information in a dynamic customer profile 110 (e.g., storing a set of electronic records each representing a customer 112, each record including, for example, one or more customer identifiers 114, trait parameters 116, etc.). Information in the dynamic customer profile 110 may be based, for example, on sensor data received from a set of sensors (e.g., via a firewall 162). According to some embodiments, a trait/feature identification engine 120 may automatically and continuously analyze the sensor data to identify potentially relevant consumer traits to grow the dynamic customer profile 110.

The recommendation platform 150 may also store information into other data stores and utilize efficacy scores (e.g., indicating the predictive importance of various customer traits and combinations of traits) from a Data Envelopment Analysis (“DEA”) engine 160 to generate appropriate recommendations for a customer. In some embodiments, the recommendation platform 150 may also exchange information with a cloud-based environment executing a business communication platform (e.g., associated with a retailer). Information about customer actions in response to a recommendation may be provided to the DEA engine 160 as feedback that can be used to improve the accuracy of future efficacy scores. According to some embodiments, an interactive graphical user interface platform of the recommendation platform 150 (and, in some cases, enterprise data and/or third-party data) may facilitate forecasts, decisions, predictions, and/or the display of communications via one or more remote administrator computers (e.g., to identify appropriate updates to recommendation rules and logic). Note that the recommendation platform 150 and/or any of the other devices and methods described herein might be associated with a third party, such as a vendor that performs a service for an enterprise.

The recommendation platform 150 and/or the other elements of the system 100 might be, for example, associated with a Personal Computer (“PC”), laptop computer, smartphone, an enterprise server, a server farm, and/or a database or similar storage devices. According to some embodiments, an “automated” recommendation platform 150 (and/or other elements of the system 100) may facilitate automated customer recommendations. As used herein, the term “automated” may refer to, for example, actions that can be performed with little (or no) intervention by a human.

As used herein, devices, including those associated with the recommendation platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The recommendation platform 150 may store information into and/or retrieve information from the dynamic customer profile 110. The dynamic customer profile 110 might be locally stored or reside remote from the recommendation platform 150. As will be described further below, the dynamic customer profile 110 may be used by the recommendation platform 150 in connection with the DEA engine 160 to generate relevant customer recommendations. Although a single recommendation platform 150 is shown in FIG. 1, any number of such devices may be included. Moreover, various devices described herein might be combined according to embodiments of the present invention. For example, in some embodiments, the recommendation platform 150, the DEA engine 160, and the dynamic customer profile 110 might be co-located and/or may comprise a single apparatus.

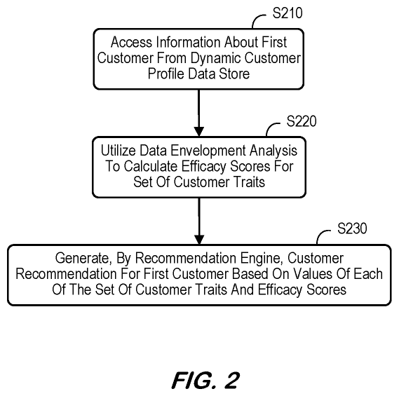

Note that the system 100 of FIG. 1 is provided only as an example, and embodiments may be associated with additional elements or components. FIG. 2 illustrates a method to facilitate an automatic determination of customer recommendations based on sensor data according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a DEA platform may access information about a first customer from a dynamic customer profile data store. The dynamic customer profile data store may, for example, contain electronic records, each record being associated with a customer and including a customer identifier and a value for each of a set of customer traits derived from sensor data.

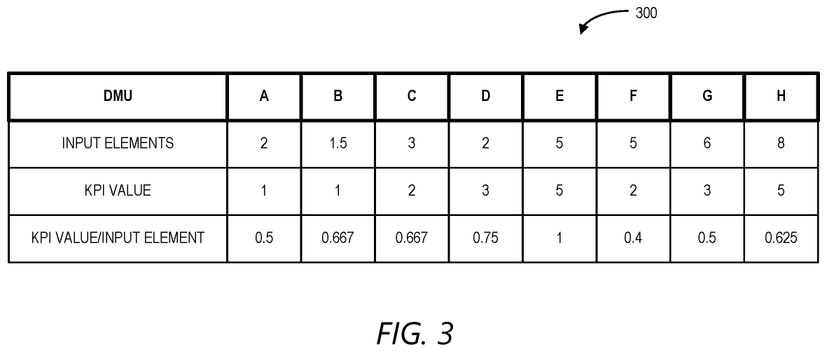

At S220, a DEA platform may utilize DEA (e.g., as described with respect to FIGS. 3 through 7) to calculate efficacy and/or efficiency scores for the set of customer traits. At S230, a recommendation engine may generate a customer recommendation for the first customer based on the values of each of the set of customer traits and the efficacy scores. Note that the customer recommendation might be associated with, for example, a retail store, a retail product, a coupon, a subscription, an online purchase, a service, online content (e.g., an online video makeup tutorial), a recommended online user, community, or group, etc. According to some embodiments, information about a customer action or reaction associated with the customer recommendation is fed back to the DEA platform.

DEA is a benchmarking and optimization technique which may be useful in connection with the analysis of multiple criteria parameters. In DEA, a metric of a unit is evaluated by comparing an amount of output produced in comparison to an amount of input used. The performance of a unit is calculated by comparing its efficiency with the best observed performance in the data set. Note that there are various DEA models, each with its own characteristics. In general, DEA is a non-parametric method (i.e., it does not use statistical distribution) that measures productivity by considering a system of inputs and outputs.

Efficiency is the ratio between an amount of output produced and an amount of input used. A “profit per employee,” a “Gross Domestic Product (“GDP”) per capita,” or an “average number of meals delivered per driver” are common examples of efficiency ratios. DEA measures the efficiency of a unit—referred to as a Decision Making Unit (“DMU”)— using a weighted ratio as follows:

$$Performance = \frac{v i rtual output}{v i rtual input} = \frac{{u}_{1} {y}_{10} + … + {u}_{s} {y}_{s 0}}{{v}_{1} {x}_{10} + … + {v}_{m} {x}_{m 0}}$$

where x and y are respectively input and output vectors, uₛ is outputₛ's weight and vₘ is inputₘ's weight. This ratio may account for all outputs and inputs and is called a “total productivity factor.” Other DEA models may implement similar types of performance ratios (with their own specific characteristics). The weights assigned to each input and each output may comprise variables used in a DEA optimization process.

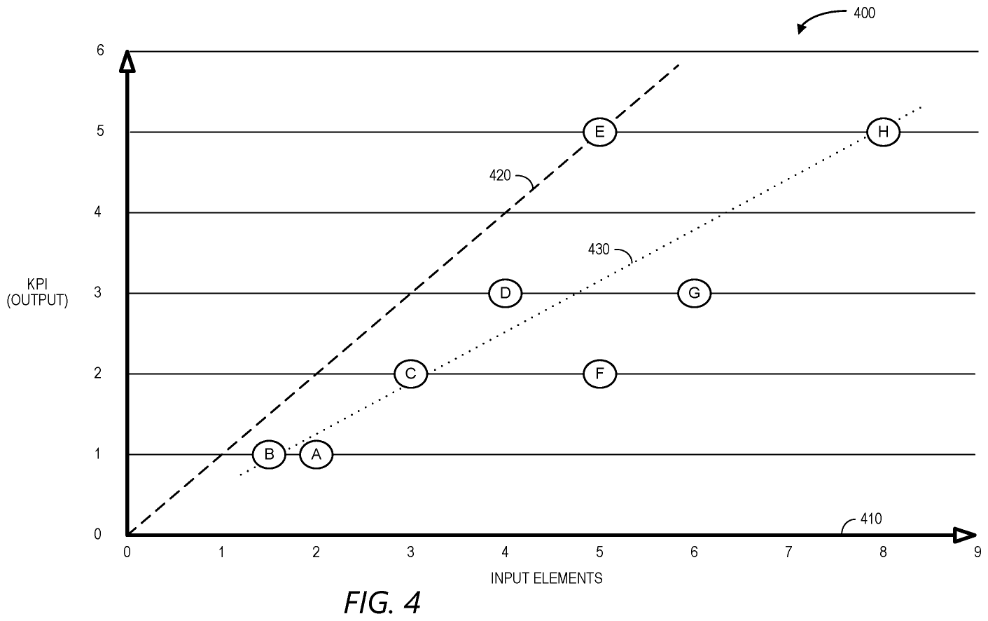

An “efficient frontier” represents the best observed performance in a data set. Consider table 300 of FIG. 3 that shows a Key Performance Indictor (“KPI”) per input element for a set of DMUs (DMU A through DMU H). The efficiency ratio (KPI/input element) can then be used to measure the efficiency. Plotting the number of input elements for each DMU on an X-axis (horizontal axis) and the KPI on a Y-axis (vertical axis) results in a graph 400 of coordinates 410 as shown in FIG. 4. FIGS. 3 and 4 can now be used to find the best performing DMUs. In this case, DMU E shows the best performance with an efficiency of 1. The dashed line 420 that spans from the origin of the coordinates 410 to DMU E is the efficiency frontier. The efficiency frontier is the best observed performance and is said to “envelop” the data. The dotted line 430 represents a regression line of the DMUs in the table 300. In DEA, the performance of a DMU may be calculated by comparing it to the efficiency frontier directly determined from the data.

All of the DMU that are not on the efficiency frontier are “inefficient” (note that a DMU on the efficiency frontier might not necessarily be efficient). An inefficient unit may adjust behaviors to move to the efficiency frontier and become efficient. There are three possible ways to do this:
reduce inputs while keeping outputs constant (an input-oriented approach),
increase outputs while keeping inputs constant (an output-orientated approach) and
both increase outputs and reduce inputs (e.g., with non-oriented versions of models).

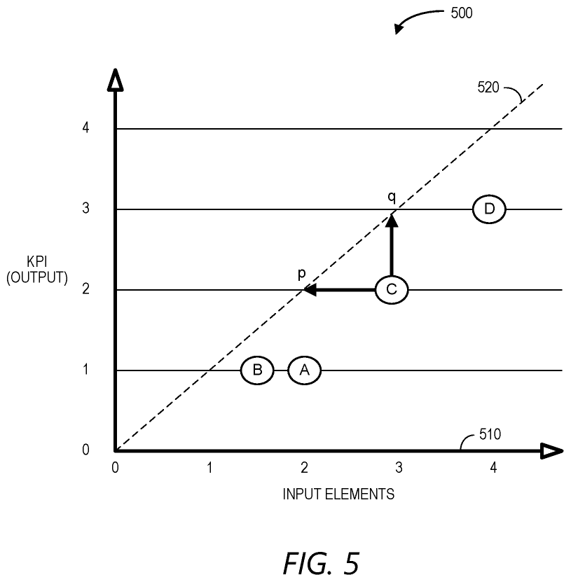

In effect, the further away from the efficiency frontier a DMU is, the worse its performance. This can be illustrated by considering DMU C from the previous graph 400 as shown in the portion of the graph 500 of coordinates 510 of FIG. 5. The graph 500 shows how DMU C can either reach the frontier 520 by reducing its inputs (while keeping its output levels constant) to reach “p” or by increasing its output (while keeping its input levels constant) to reach “q.”

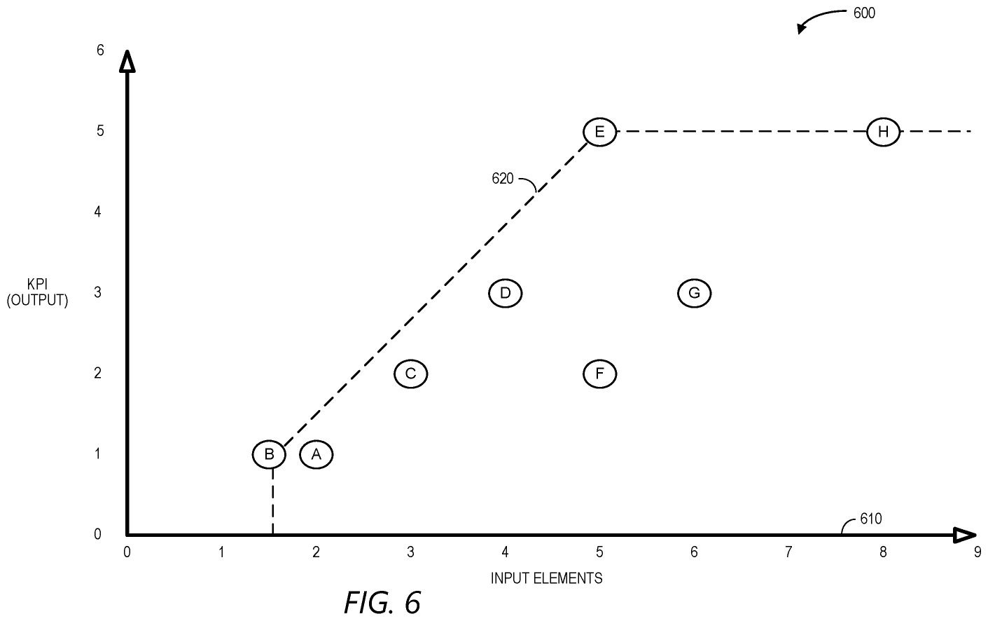

Note that the frontier lines previously shown herein assume that the lines can stretch to infinity; i.e., that the performance levels of DMU E (the only efficient DMU) are possible regardless of the number of input elements. This is called a Constant Returns To Scale (“Constant RTS”). Although the Constant RTS assumption is sometimes true for a local range of production, in other cases it may need to be relaxed. This is possible with—for example—Variable RTS which are illustrated in the graph 600 of coordinates 610 shown in FIG. 6.

Note that under Variable RTS, DMU B becomes efficient and is on the efficiency frontier line 620. Although DMU H is also on the efficiency frontier line, it is not efficient because it produces a similar amount of KPI (i.e., 5) but uses three more input units to do so. In order for DMU H to be efficient, it needs to reduce its input elements by three in order to reach E's coordinates. DMU H could also become efficient by increasing its KPI. However, there is no way to know if this is possible because those production levels are not observed in the data (i.e., the area above the current efficiency frontier line 620). Other types of RTS exist such as Increasing RTS (also called Non-Decreasing RTS) which assume that it is not possible to reduce the scale of a DMU but that RTS can be stretched to infinity. Another type of RTS (with the opposite assumption) is Decreasing RTS (also called Non-Increasing RTS). Finally, a General RTS model lets the model control how much the scale of a DMU can be reduced or increased.

Note that two types of inefficiency exist:
technical inefficiency, and
mix inefficiencies.

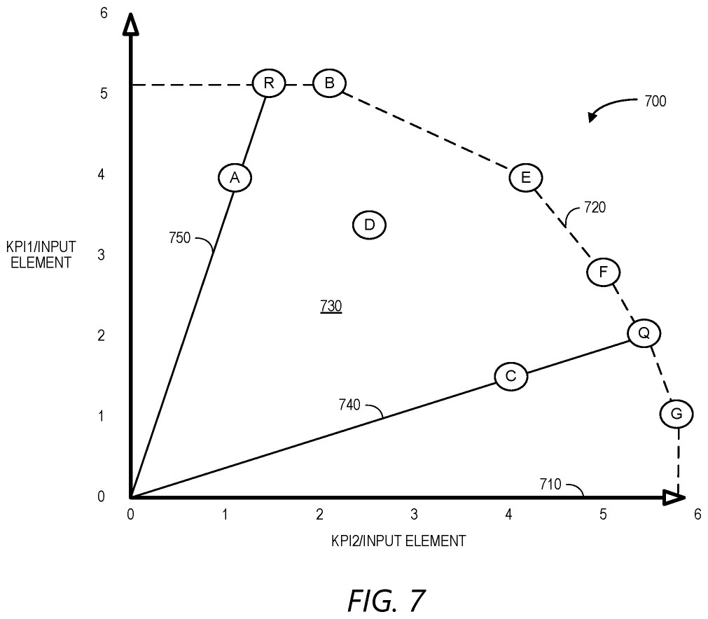

The difference between the two is shown in the graph 700 on the coordinates 710 of FIG. 7. The graph 700 illustrates the performance of different DMUs based on two outputs: KPI1 and KPI2, and one input: a number of input elements. It is possible to illustrate the performance of each DMU by plotting KPI1/input element and KPI2/input element ratio values as shown on the graph 700 to create an efficiency frontier line 720. A region 730 under the efficiency frontier line 720 is referred to as a “production possibility set” and represents a region of possible production (based on the observed performances in the data set)

On this graph 700, DMU C is not efficient because it is not on the efficiency frontier line 720. In order for DMU C to become efficient, it needs to reach the efficiency frontier line by projecting 740 onto point Q. This radial projection corresponds to the technical inefficiency of DMU C. DMU A is also not efficient. However, when projecting 750 onto the efficient frontier to point R (technical inefficiencies), DMU A is still not efficient because another DMU exists (DMU B) which illustrates proportionally greater KPI2 per input element. In order for DMU A to become efficient, it first needs to project 750 onto the efficiency frontier line 720 and then increase KPI2 per input element until it reaches DMU B (mix inefficiencies).

Technical inefficiencies can thus be eliminated without changing the proportions between inputs and outputs while mix inefficiencies can only be eliminated by changing the proportion (mix) between inputs and outputs. Different DEA models may have different approaches as to how the technical and mix inefficiencies are evaluated. In general, DMUs are efficient when they exhibit no technical inefficiencies and no mix inefficiencies.

DEA uses a total factor productivity ratio to measure performance (i.e., a unique ratio with all the inputs and outputs). DEA attributes a virtual weight to each of these inputs and outputs. The performance of an entity may then be calculated using a linear optimization process which tries to maximize each entity's ratio by finding the best set of weight for that particular entity. The optimization process may be constrained by existing data so that each entity is compared against the best observed performance.

According to some embodiments, the DEA approach may be used to determine efficacy scores for traits in a dynamic customer profile. Note that recommending the right products and displaying the most relevant content on an online platform is an important task for retailers today. The relevancy of such proposals will be directly proportional to the satisfaction it generates for customers, and, hence, lead to higher revenue for the business. It is therefore important to build a deeper understanding of customers by engaging with them in a continuous dialog and/or in a myriad ways. Some embodiments described herein use a methodology to build an evolutionary understanding of an individual customer by focusing on:
learning new traits about an individual customer by continuously collecting data via sensors, and
continuously measuring the effectiveness and efficacy of each trait/feature identified via sensors using DEA and using the efficacy score as a feedback to a recommendation engine to further improve hyper-personalized recommendations.

A business platform may be an appropriate platform to generate and propose highly personalized content because it is associated with enterprise applications that drive customer segmentation, marketing campaigns, and content management. This provides a value to the customers of a retailer and may eventually lead to improved customer satisfaction, better happiness scores, and higher repeat/return customers.

Hyper-personalization may require a capability to not only understand the intent of a customer during a current interaction (e.g., in substantially real-time) but may also involve building an evolutionary understanding of an individual. Note that preferences of an individual might not remain the same and can be influenced by ever-changing social, financial, geospatial, cultural, spiritual influences and an even evolving value system of the customer. Traditional macro-segmentation based on a fixed number of traits may not be sufficient because it yields less relevant recommendations for an individual (it does not take into consideration the dynamic nature of individual traits and changing external factors).

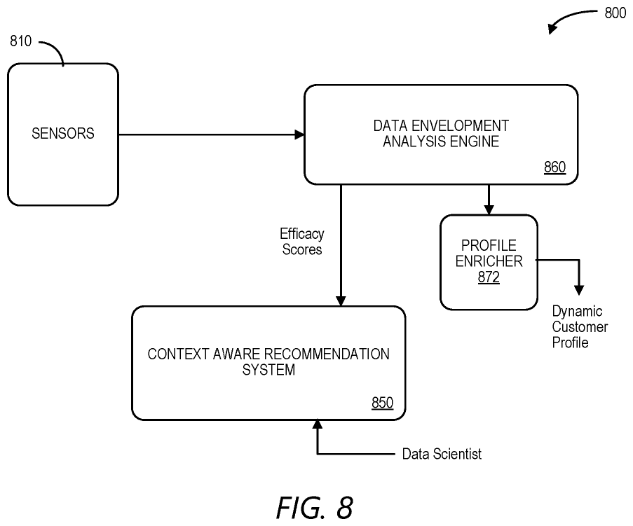

Embodiments described herein may effectively use a combination of sensors, DEA, and a hybrid, reinforcement-based recommendation engine to churn hyper-personalized recommendations that have continuously improving relevancy. FIG. 8 is a system architecture 800 according to some embodiments. Sensors 810 provide sensor data to a DEA engine 860. The DEA engine 860 may provide efficacy scores to a context aware recommendation system 850 and information to profile enricher 872 (to update a dynamic customer profile). According to some embodiments, a data scientist may also provide input to the recommendation system 850 (e.g., to adjust recommendation logic).

The sensors 810 may comprise virtual and/or physical entities that capture information about an individual and/or an environment. This information might be used to derive, for example:
personality traits of an individual (e.g., physical, psychological, or behavioral),
cultural/social traits that a person exhibits or shows inclination towards,
environmental/geospatial traits (e.g., temperature, humidity, air toxicity, etc.), and
temporal events that are transient in nature and time sensitive (e.g., a pandemic, a festival, or any special occasion).
   Note that these are just some examples of what could be derived and should not be considered an exhaustive list. Each of these sensors may be used to capture a snapshot or a continuous stream of information about an individual and/or the individual's surrounding.

The DEA engine 860 may evaluate the relative efficiencies of customer traits. Given the sensor inputs, the DEA engine 860 may analyze the impact of each trait on the recommendation which that is output from the recommendation system 850. Relative efficiency may be, for example, measured based on how well the recommendations are received by individual customers.

Note that the beauty industry in general is highly personalized (e.g., makeup, hair style, fashion, etc.). A product that works for one customer might not be equally effective for another customer. There is a growing focus in the industry on manufacturing products that target a demographic sub-section to increase efficacy. Brands are now looking at innovative ways to capture personalized information about users to come up with recommendations that may only be relevant for that particular individual. One embodiment will therefore be described using the online beauty retail industry as a use case. Note, however, that the concepts presented herein are applicable in general to the online retail industry (and, in some cases, brick-and-mortar retail stores).

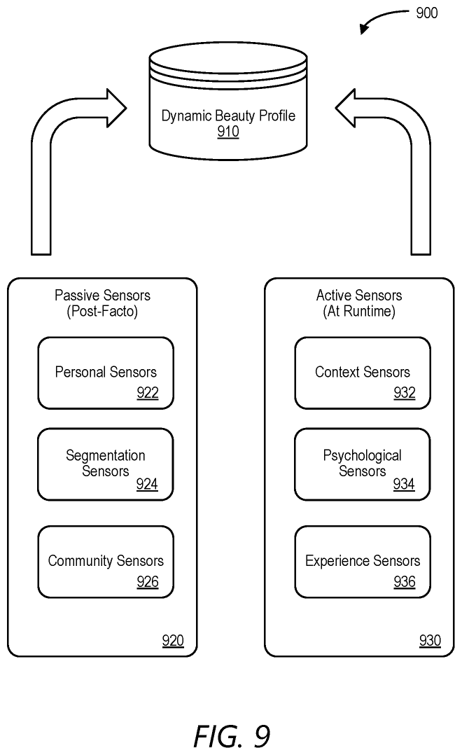

FIG. 9 is a beauty sensor information collection system 900 that can populate a dynamic beauty profile 910 in accordance with some embodiments. The dynamic beauty profile 910 may, for example, receive information from passive sensors 920 that periodically collect information. In particular, personal sensors 922 may capture an individual's preferences, aesthetics (such as face shape), skin tone, hair texture, purchase history, social media insights, etc. Similarly, segmentation sensors 924 and/or community sensors 926 may capture user preferences, the purchase/browse history of a customer and other individuals connected to (e.g., in a shared community of members) or followed by the customer (e.g., influencers).

The dynamic beauty profile 910 may also receive information from active sensors 930 at runtime, such as during a customer's use of an application. In particular, context sensors 932 may comprise live temporal sensors during the occasion of a purchase, location, ambient conditions, facial demographics, etc. Similarly, psychological sensors 934 may comprise live sensors that track behavior and sentiment when the user interacts with the application (e.g., eye tracking, facial sentiment recognition, heart rate, etc.). Experience Sensors 936 may track live search patterns, preferences of categories or products, preferred content, a price segment, a promotion, etc.

According to some embodiments, public content and context sensors may gather non-personal data about consumer. These are situational, seasonal, and non-personal context sensitive data points that may influence the preferences and decision making of a customer during their interaction with an application. Public content sensors might collect, for example, scores for trending social media content, content data and information of products, trending products and sales, trend data from ecosystem partners, etc. Public context sensors might collect seasonality data and other demand influencing factors, application-wide promotions and campaigns, etc.

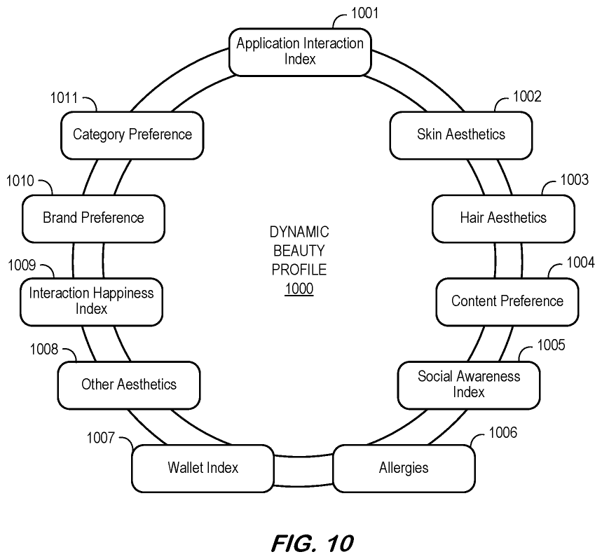

The sensor information may then be combined to construct a dynamic beauty profile of the customer. For example, FIG. 10 is an example of a dynamic beauty profile 1000 according to some embodiments. As illustrated in FIG. 10, the profile 1000 might include information about: an application interaction index 1001, skin aesthetics 1002, hair aesthetics 1003, content preference 1004, a social awareness index 1005, allergies 1006, a wallet index 1007, other aesthetics 1008, an interaction happiness index 1009, brand preference 1010, category preference 1011, etc. In general, the dynamic beauty profile 1000 is a collection of traits that are continuously learned (via passive and active sensors).

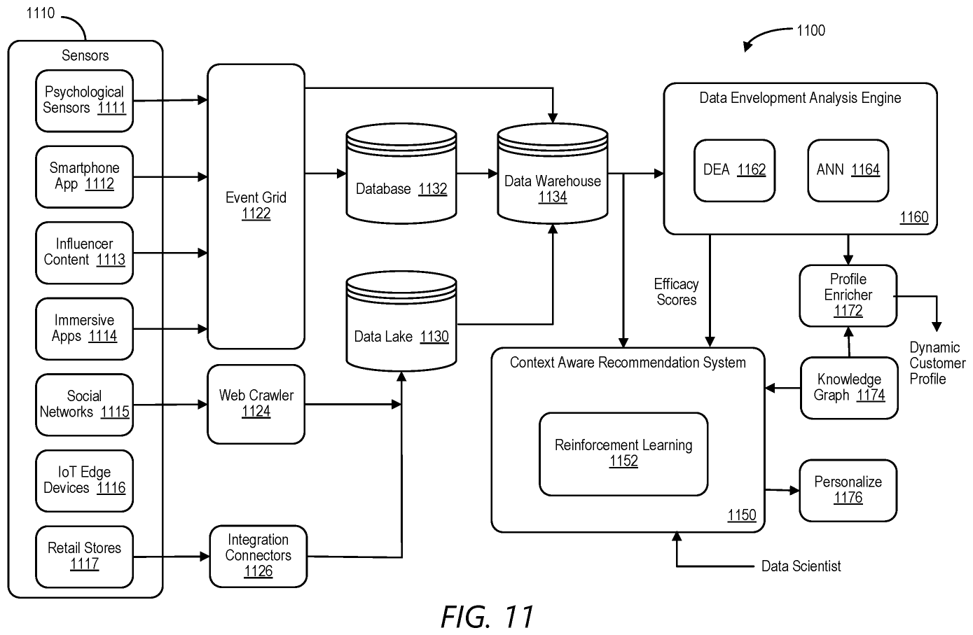

FIG. 11 is a more detailed system architecture 1100 that highlights data flows and interaction with key components in accordance with some embodiments. A set of sensors 1110 may include psychological sensors 1111 that provide a data stream for facial analysis which is fed into an emotion Artificial Intelligence (“AI”) engine, such as a Convolutional Neural Network (“CNN”) to derive sentiment/mood. This may comprise a live/active sensor that is mostly active while the user is interacting with a smart device. According to some embodiments, the psychological sensors 1111 may store information into various data stores (e.g., database 1132 and data warehouse 1134) via an event grid 1122.

A smartphone interaction sensor 1112 may be associated with retail applications on a smartphone that generate user interaction and click stream data. This may help understand how a customer is interacting with different parts of the application. Customer preferences and/or inclinations might, for example, be derived by analyzing smartphone interaction sensor 1112 data. According to some embodiments, the smartphone interaction sensor 1112 may store information into various data stores via the event grid 1122.

An influencer/expert content sensor 1113 may be associated with domain experts and influencers who generate content such as product reviews, brand/product promotions, identifying trends, etc. These feeds may influence a customer's purchase decisions of the consumers. Each feed might be analyzed to extract:
sentiments of an expert for one or more products., and
segmentation traits based on bodily features, allergies, climate, temporal indicators, etc.

Expert content, together with the user interaction analysis, may reveal new preferences and/or inclinations of a customer (which can translate into new traits). According to some embodiments, the influencer/expert content sensor 1113 may store information into various data stores via the event grid 1122.

A lot of innovation is happening in the beauty industry to develop physical smart services and virtual devices (applications) using capabilities such as Augmented Reality (“AR”) to “try” various makeup products, eyeglasses, hairstyles, etc. These capabilities can help determine physical attributes of an individual, such as hair texture, skin type, etc. Data extracted from these sources via an immersive application sensor 1114 may help build a physical profile of an individual. According to some embodiments, the immersive application sensor 1114 may store information into various data stores via the event grid 1122.

Individuals may be influenced by the company they keep. Social networks sensors 1115 may provide the publicly available data of an individual and his/her network. Circle of influences are then created with larger weights giving to direct contacts and lesser weights given to indirect contacts (weights determine an impact that a contact has on an individual). Mining of posts of an individual and their network may be done to learn preferences and inclinations which creates new traits for an individual. As an individual evolves and changes, the network ensures that these traits are re-learned. Social networks may also be mined (e.g., via a web crawler 1124) to identify new trend setters, identify domain specific thought leaders, etc.

An Internet of Things (“IoT”) edge device sensor 1116 may collect information from various smart appliances, automobile sensors, wearable sensors, etc. to further augment a dynamic beauty profile. Moreover, a retail store sensor 1117 might be associated with a beauty center, such as a makeup store or hair salon. Beauty centers are an integral part of beauty industry and may experience the largest touch point to end customers. Integration of retail store sensors 1117 to an online retail platform (e.g., to a data lake 1130 via integration connectors 1126) may provide customer and product usage insights that would be otherwise difficult to obtain. For example, a distributed network of retail store sensors 1117 might collect: geospatial preference of products, user segmentation with respect to a type of user, preference of users, allergies of users, etc.

Based on the type of data streams generated from each of these sensors 1110, different cognitive services such as speech transcription, translation, computer vision libraries, video indexing/annotating, sentiment and behavior analysis, etc. may be employed to categorize and annotate data. The sensor 1110 data may then be processed by a DEA engine 1160 (including DEA 1162 and an Artificial Neural Network (“ANN”) 1164 to create efficacy scores. According to some embodiments, analysis of continuous feeds coming from various sensors 1110 results in identification of new traits which together constitute an evolving user profile (e.g., via a profile enhancer 1172). The number of traits may increase over time and therefore it is required to continuously measure relative efficiency of traits. A context aware recommendation system 1150 (with reinforcement learning 1152) may also receive the streams of sensor 1110 data and efficacy scores, along with inputs from data scientists and a knowledge graph 1174) to create personalized 1176 recommendations for a customer.

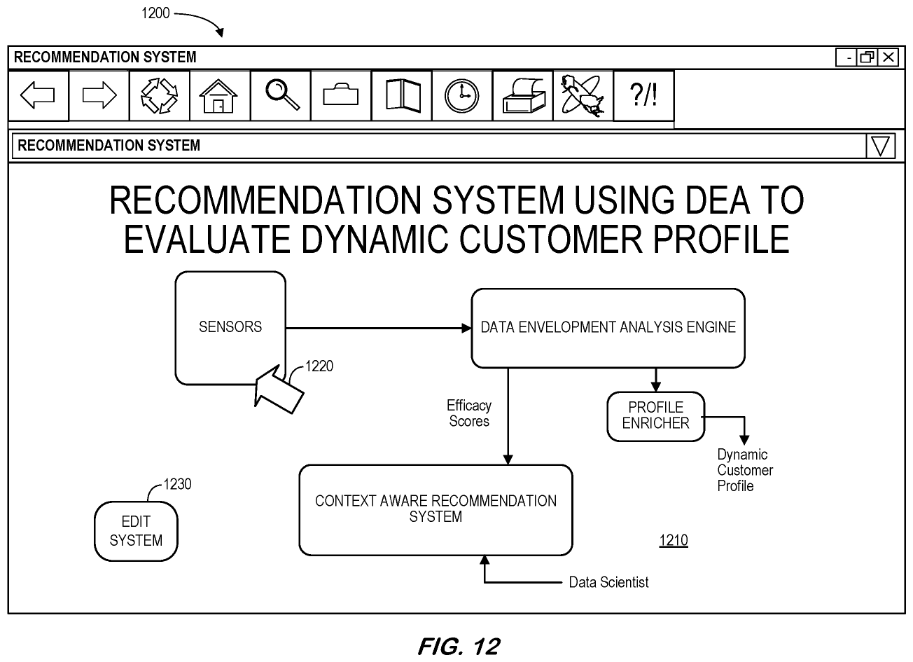

FIG. 12 is a human machine interface display 1200 in accordance with some embodiments. The display 1200 includes a graphical representation 1210 or dashboard that might be used to manage or monitor a recommendation system framework (e.g., associated with a cloud provider or business platform). In particular, selection of an element (e.g., via a touchscreen or computer mouse pointer 1220) might result in the display of a popup window that contains configuration data. The display 1200 may also include a user selectable “Edit System” icon 1230 to request system changes (e.g., to investigate or improve system performance, add sensors, or adjust recommendation rules or products).

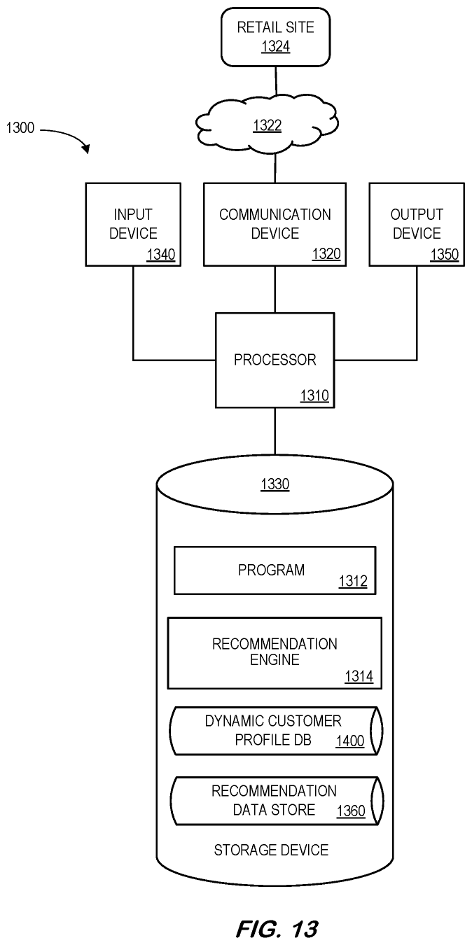

Note that the embodiments described herein may be implemented using any number of different hardware configurations. For example, FIG. 13 is a block diagram of an apparatus or platform 1300 that may be, for example, associated with the system 100 of FIG. 1 (and/or any other system described herein). The platform 1300 comprises a processor 1310, such as one or more commercially available CPUs in the form of one-chip microprocessors, coupled to a communication device 1320 configured to communicate via a communication network (not shown in FIG. 13). The communication device 1320 may be used to communicate, for example, with one or more remote customer platforms or retail sites 1324 via a communication network 1322. The platform 1300 further includes an input device 1340 (e.g., a computer mouse and/or keyboard to input data about sensors or retailers) and an output device 1350 (e.g., a computer monitor to render a display, transmit recommendations or alerts, and/or create business reports). According to some embodiments, a mobile device and/or PC may be used to exchange data with the platform 1300.

The processor 1310 also communicates with a storage device 1330. The storage device 1330 can be implemented as a single database or the different components of the storage device 1330 can be distributed using multiple databases (that is, different deployment data storage options are possible). The storage device 1330 may comprise any appropriate data storage device, including combinations of magnetic storage devices (e.g., a hard disk drive), optical storage devices, mobile telephones, and/or semiconductor memory devices. The storage device 1330 stores a program 1312 and/or recommendation engine 1314 for controlling the processor 1310. The processor 1310 performs instructions of the programs 1312, 1314, and thereby operates in accordance with any of the embodiments described herein. For example, the processor 1310 may access information about a first customer and utilize DEA to calculate efficacy scores for a set of customer traits. The processor 1310 may then generate a customer recommendation for the first customer based on values of each customer trait and the efficacy scores. Information about a customer action associated with the customer recommendation may be fed back to the processor 1310.

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, data may be “received” by or “transmitted” to, for example: (i) the platform 1300 from another device; or (ii) a software application or module within the platform 1300 from another software application, module, or any other source.

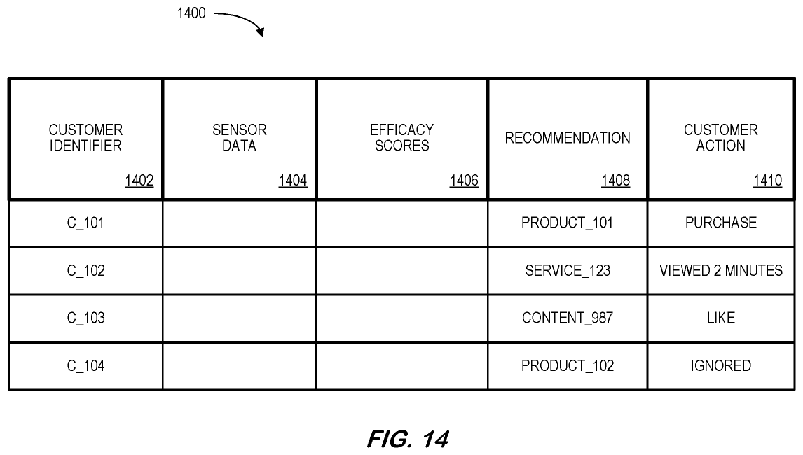

In some embodiments (such as the one shown in FIG. 13), the storage device 1330 further stores a dynamic customer profile database 1400 and recommendation data store 1360. An example of a database that may be used in connection with the platform 1300 will now be described in detail with respect to FIG. 14. Note that the database described herein is only one example, and additional and/or different data may be stored therein. Moreover, various databases might be split or combined in accordance with any of the embodiments described herein.

Referring to FIG. 14, a table is shown that represents the dynamic customer profile database 1400 that may be stored at the platform 1300 according to some embodiments. The table may include, for example, entries identifying associated with customers of a business, retailer, or online platform. The table may also define fields 1402, 1404, 1406, 1408, 1410 for each of the entries. The fields 1402, 1404, 1406, 1408, 1410 may, according to some embodiments, specify: a customer identifier 1402, sensor data 1404, efficacy scores 1406, a recommendation 1408, and a customer action 1410. The dynamic customer profile database 1400 may be created and updated, for example, when new sensor data is collected, new traits are added to a profile, a customer makes a purchase, etc.

The controller identifier 1402 might be a unique alphanumeric label or link that is associated with a customer who will receive recommendations. The sensor data 1404 can include any of the information described herein, including information from passive sensors, active sensors, public content sensors, public context sensors, etc. The efficacy scores 1406 may indicate how effective various traits are with respect to generating appropriate recommendations. The recommendation 1408 may suggest a product, service, content, etc. to the customer. The customer action 1410 might indicate that the person associated with the customer identifier 1402 made a purchase, viewed information (e.g., was thinking about a purchase), liked content or commented on social media, or even ignored the recommendation 1408 (e.g., indicating that the suggestion was not too relevant for that particular person).

In this way, embodiments may facilitate an automatic determination of customer recommendations based on sensor data in an efficient and accurate manner. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

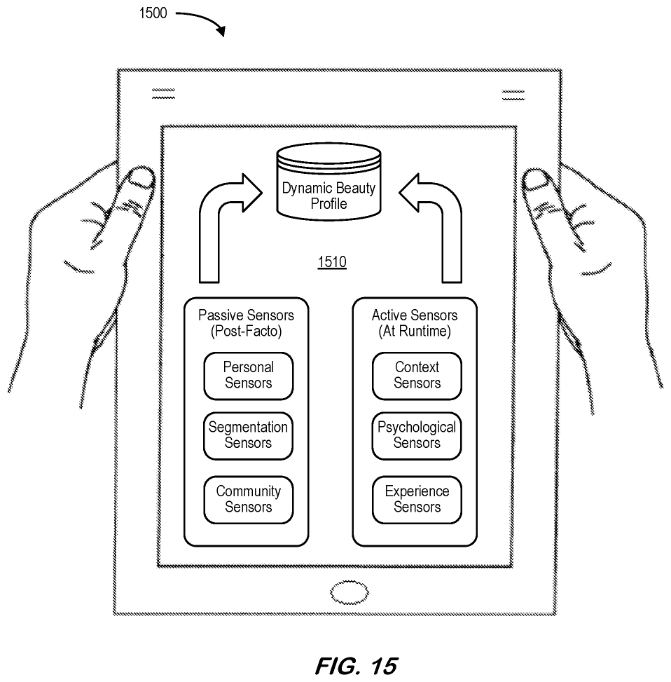

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of products and retail stores, any of the embodiments described herein could be applied to other types of businesses. Moreover, the displays shown herein are provided only as examples, and any other type of user interface could be implemented. For example, FIG. 15 shows a handheld tablet computer 1500 rendering a dynamic customer profile display 1510 that may be used to view or adjust existing recommendation system framework components and/or to request additional data (e.g., via a “More Info” icon not shown in FIG. 15).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system to generate customer recommendations based on sensor data, comprising:
a dynamic customer profile data store containing electronic records, each record being associated with a customer and including a customer identifier and a value for each of a set of customer traits derived from sensor data; and
a data envelopment analysis platform, coupled to the dynamic customer profile data store, including:
a computer processor, and
a computer memory storing instructions that, when executed by the computer processor, cause the data envelopment analysis platform to:
(i) access information about a first customer from the dynamic customer profile data store, and
(ii) utilize data envelopment analysis to calculate efficacy scores for the set of customer traits; and
a recommendation engine, coupled to the dynamic customer profile data store and data envelopment analysis platform, to generate a customer recommendation for the first customer based on the values of each of the set of customer traits and the efficacy scores,
wherein information about a customer action associated with the customer recommendation is fed back to the data envelopment analysis platform.

2. The system of claim 1, wherein one of the traits in the dynamic customer profile data store is associated with at least one of: (i) a personality traits, (ii) a physical trait, (iii) a psychological trait, (iv) a behavioral trait, (v) a cultural trait, (vi) a social trait, (vii) an environmental trait, (viii) a geospatial trait, (ix) a temperature, (x) a humidity, (xi) air toxicity, (xii) a temporal event, (xiii) a festival, (xiv) a snapshot of customer information, and (xv) a continuous stream of customer information.

3. The system of claim 1, wherein the sensor data is generated by a plurality of remote sensors.

4. The system of claim 3, wherein at least one of the plurality of remote sensors is associated with a passive sensor.

5. The system of claim 4, wherein the passive sensor is associated with at least one of: (i) periodically collected information, (ii) a personal sensors that captures customer preferences, (iii) aesthetics, (iv) face shape, (v) skin tone, (vi) hair texture, a segmentation sensor, (vii) a community sensors, (viii) customer purchase history, (ix) customer web browsing history, and (x) information about community members associated with customers.

6. The system of claim 3, wherein at least one of the plurality of remote sensors is associated with an active sensor.

7. The system of claim 6, wherein the active sensor is associated with at least one of: (i) a real-time context sensor, (ii) a psychological sensor, (iii) an experience sensor, (iv) a live temporal sensor, (v) a psychological sensors that tracks customer behavior and sentiment as the customer interacts with an application, (vi) an experience sensors that tracks live search patterns, (vii) customers preferences of categories or products, (viii) seasonality data, and (ix) retail promotions or campaigns.

8. The system of claim 3, wherein at least one of the plurality of remote sensors is associated with at least one of: (i) a public content sensor, (ii) trending social media content, (iii) content data and information of products, and (iv) trending products and sales from an ecosystem partner.

9. The system of claim 3, wherein at least one of the plurality of remote sensors is associated with at least one of: (i) a smartphone interaction sensor, (ii) an influencer sensor, (iii) an expert content sensor, (iv) an immersive application sensor, (v) a social network sensor, and (vi) a retail store sensor.

10. The system of claim 3, wherein traits are automatically added to the dynamic customer profile data store by a feature identification engine that analyzes the sensor data.

11. A computer-implemented method to generate customer recommendations based on sensor data, comprising:
accessing, by a data envelopment analysis platform, information about a first customer from a dynamic customer profile data store, wherein the dynamic customer profile data store contains electronic records, each record being associated with a customer and including a customer identifier and a value for each of a set of customer traits derived from sensor data;
utilizing, by the data envelopment analysis platform, data envelopment analysis to calculate efficacy scores for the set of customer traits; and
generating, by a recommendation engine, a customer recommendation for the first customer based on the values of each of the set of customer traits and the efficacy scores,
wherein information about a customer action associated with the customer recommendation is fed back to the data envelopment analysis platform.

12. The method of claim 11, wherein one of the traits in the dynamic customer profile data store is associated with at least one of: (i) a personality traits, (ii) a physical trait, (iii) a psychological trait, (iv) a behavioral trait, (v) a cultural trait, (vi) a social trait, (vii) an environmental trait, (viii) a geospatial trait, (ix) a temperature, (x) a humidity, (xi) air toxicity, (xii) a temporal event, (xiii) a festival, (xiv) a snapshot of customer information, and (xv) a continuous stream of customer information.

13. The method of claim 11, wherein the sensor data is generated by a plurality of remote sensors.

14. The method of claim 13, wherein at least one of the plurality of remote sensors is associated with a passive sensor.

15. The method of claim 14, wherein the passive sensor is associated with at least one of: (i) periodically collected information, (ii) a personal sensors that captures customer preferences, (iii) aesthetics, (iv) face shape, (v) skin tone, (vi) hair texture, a segmentation sensor, (vii) a community sensors, (viii) customer purchase history, (ix) customer web browsing history, and (x) information about community members associated with customers.

16. The method of claim 13, wherein at least one of the plurality of remote sensors is associated with an active sensor.

17. The method of claim 16, wherein the active sensor is associated with at least one of: (i) a real-time context sensor, (ii) a psychological sensor, (iii) an experience sensor, (iv) a live temporal sensor, (v) a psychological sensors that tracks customer behavior and sentiment as the customer interacts with an application, (vi) an experience sensors that tracks live search patterns, (vii) customers preferences of categories or products, (viii) seasonality data, and (ix) retail promotions or campaigns.

18. A non-transitory, computer-readable medium storing instructions, that, when executed by a processor, cause the processor to perform a method to generate customer recommendations based on sensor data, the method comprising:
receiving a stream of sensor data from a plurality of remote sensors;
automatically adding, by a feature identification engine that analyzes the sensor data, traits to a dynamic customer profile data store that contains electronic records, each record being associated with a customer and including a customer identifier and a value for each of a set of customer traits derived from sensor data;
accessing, by a data envelopment analysis platform, information about a first customer from the dynamic customer profile data store, wherein the dynamic customer profile data store;
utilizing, by the data envelopment analysis platform, data envelopment analysis to calculate efficacy scores for the set of customer traits; and
generating, by a recommendation engine, a customer recommendation for the first customer based on the values of each of the set of customer traits and the efficacy scores,
wherein information about a customer action associated with the customer recommendation is fed back to the data envelopment analysis platform.

19. The medium of claim 18, wherein at least one of the plurality of remote sensors is associated with at least one of: (i) a public content sensor, (ii) trending social media content, (iii) content data and information of products, and (iv) trending products and sales from an ecosystem partner.

20. The medium of claim 18, wherein at least one of the plurality of remote sensors is associated with at least one of: (i) a smartphone interaction sensor, (ii) an influencer sensor, (iii) an expert content sensor, (iv) an immersive application sensor, (v) a social network sensor, and (vi) a retail store sensor.
